(19) United States
(12) Patent Application Publication
(10) Pub. No.: US 2002/0159873 A1
(43) Pub. Date: Oct. 31, 2002

(54) Apparatus for towing a service vehicle by a truck tractor

(76) Inventors: Roy A. Amos, Portland, OR (US); James A. Woods, Cornelius, OR (US)

Correspondence Address: James D. Givnan, Jr., 8175 S. W. Ernst Road, Portland, OR, 97225, US

(21) Appl. No.: 09/843,346

(22) Filed: Apr. 27, 2001

(51) Int. Cl. B60P 3/12

(52) U.S. Cl. 414/563

(57) ABSTRACT

The apparatus is for installation in a pickup truck box and includes a tow beam extensibly carried in a support member positioned by a hydraulic cylinder to enable vertical positioning of the tow beam during coupling of the beam end to the truck tractor fifth wheel. Downward movement of the distal end of the beam, when coupled to a truck tractor, lifts the pickup truck rear end for towing of same to a site for servicing of the truck tractor. Truck tractor retrieval may accordingly be accomplished by a single workman.

### BACKGROUND OF THE INVENTION

The servicing of truck tractors often entails retrieving the truck tractor from a remote site for delivery to the shop performing periodic maintenance work. Present practice involves the use of two persons, one driving the service vehicle to the site of the truck tractor and accompanied by a second party to drive the truck tractor to the maintenance shop. The practice of using two workmen for the retrieval of a truck tractor to be serviced constitutes a costly effort from a man-hour standpoint over a period of several months. No provision is made to facilitate the towing of a small service vehicle used in such work by a truck tractor to be serviced, which would enable the retrieval of a truck tractor by a single workman.

U.S. Pat. No. 4,555,214 discloses a towing beam fitted at its ends with king pins with one end of the beam also fitted with a hydraulic cylinder for lifting the distal end of the beam for fifth wheel engagement. A lift chain on the beam extends about the rear frame members of a truck tractor to be towed with the chain lifted by a second cylinder. The system enables the towing of an over-the-road tractor by a second like tractor both having a fifth wheel. Such a system entails the use of two semi-truck tractors which is both costly and cumbersome with limited maneuverability.

U.S. Pat. No. 5,988,664 discloses a frame carried by the fifth wheel of a truck to be towed with the framework attachable to the fifth wheel of a towing truck tractor. A pivotally mounted beam is positionable by a hydraulic cylinder capable of imparting upward movement to the framework which lifts the frame of the towed tractor for towing purposes. Both vehicles must be fifth wheel equipped.

U.S. Pat. No. 4,000,823 discloses a pickup truck mounted apparatus including a hydraulic cylinder for raising a tow bar engaged with the front end of the vehicle to be towed.

U.S. Pat. No. 4,543,030 discloses an apparatus for placement on a fifth wheel of a truck tractor and having a towing beam adjustably mounted with the beam having a crosswise tow bar at its distal end for lifting engagement with a towed vehicle. A pair of lift cylinders supported by the tow truck frame impart motion to the adjustably carried tow beam.

U.S. Pat. No. 5,845,920 shows an apparatus for towing a truck with a tow truck vehicle both equipped with fifth wheels. A tow beam is segmented and houses a hydraulic cylinder for lifting a beam segment coupled to the fifth wheel of the towed truck. A lift chain also serves to elevate the towed vehicle.

### SUMMARY OF THE PRESENT INVENTION

The present invention is embodied in a towing apparatus suitable for installation in the box of a small truck enabling the truck to be towed by a semitrailer truck tractor to a maintenance facility.

The apparatus is carried within the bed of a pickup truck or other suitable vehicle with a tow beam being extensible therefrom for engagement with the fifth wheel of a truck tractor to be serviced. A base of the apparatus houses hydraulic components as well as a power source to render the apparatus self contained. As a pickup truck or other service vehicle becomes the towed vehicle, as opposed to a truck tractor, the apparatus may be of a size and weight to be fully contained within a pickup truck box. The apparatus, being self contained, is readily transferable from one vehicle to another. A hydraulic cylinder positions a support member for the tow beam which, upon coupling to the fifth wheel of a towing vehicle (truck tractor), serves as a lever to lift the apparatus and the rear end of a pickup truck or other vehicle in which the base is mounted. Mechanical locks secure the tow beam against axial displacement.

Important objectives include the provision of a tow apparatus which permits installation in a light duty service vehicle, such as a quarter ton pickup truck, permitting a single operator to retrieve a semitrailer truck tractor from a remote location by enabling rapid attachment of the light duty vehicle to the truck tractor and subsequent lifting of the same for towing purposes; the provision of an apparatus for installation in a pickup truck which enables the towing of same by a semitrailer truck tractor; the provision of an apparatus which is compact shape and of light weight to permit permanent mounting, if so desired, in a pickup truck while leaving space in the truck box for other articles to be transported.

### BRIEF DESCRIPTION OF THE DRAWINGS

In the drawings:

FIG. 1 is an elevational view of the present apparatus in use to tow a pickup truck;

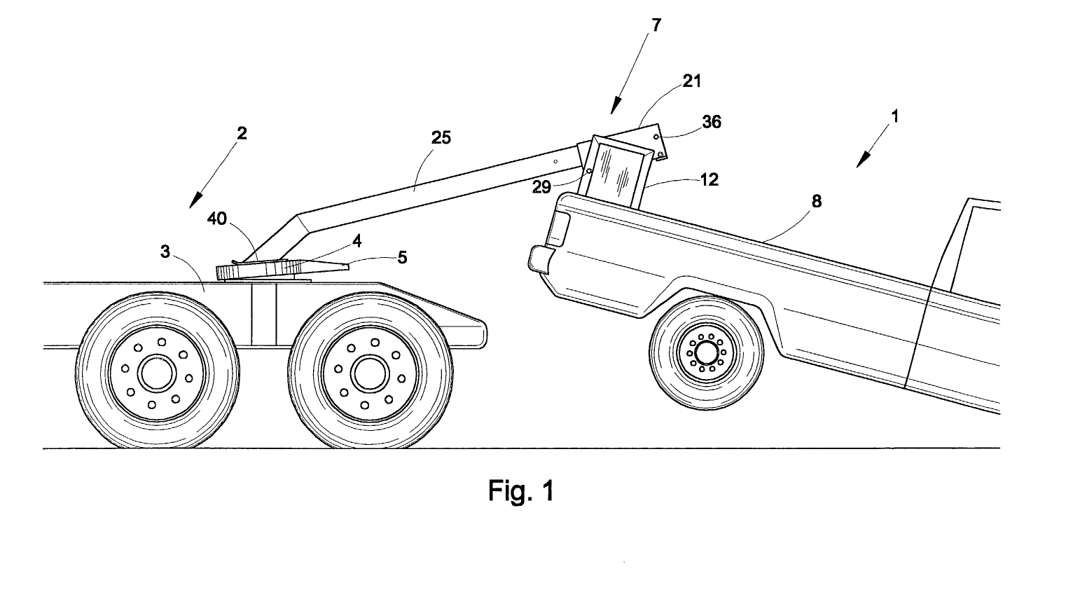

FIG. 2 is a view similar to FIG. 1 but with fragments broken away for illustrative purposes;

FIGS. 3 and 4 are perspective views of the apparatus respectively in retracted and extended positions;

FIG. 5 is a plan view of the apparatus in an extended positions;

FIG. 6 is a vertical sectional view taken along line 6-6 of FIG. 3.

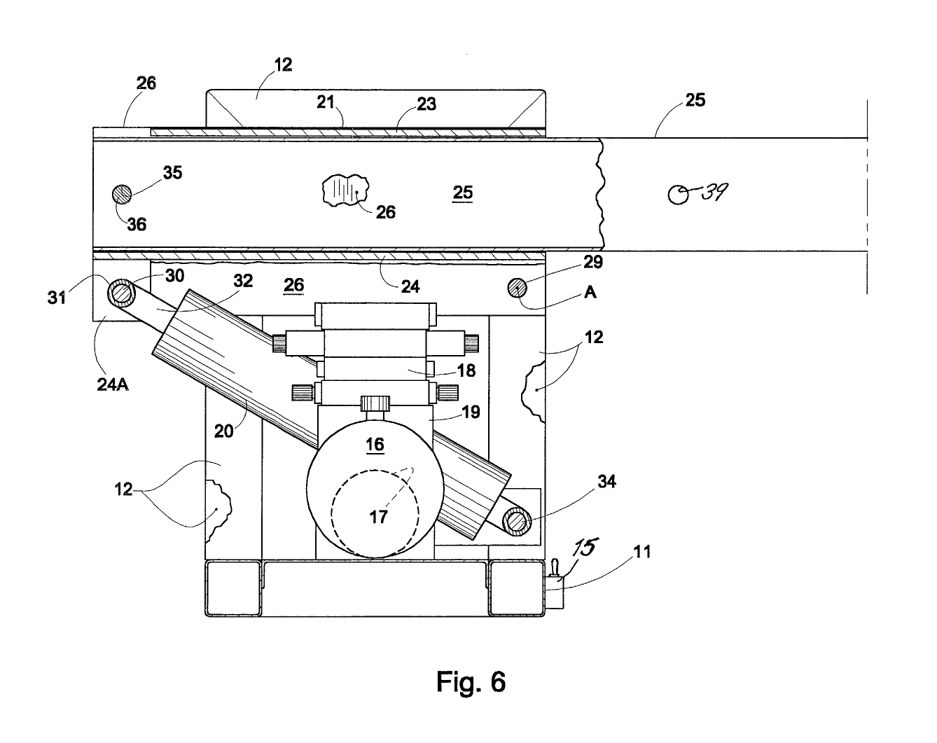

### DETAILED DESCRIPTION OF THE PREFERRED EMBODIMENTS

With continuing attention to the drawings wherein applied reference numerals indicate parts similarly hereinafter identified, the reference numeral 1 indicates generally a pickup truck for use by the person assigned the task of retrieving the truck tractor indicated generally at 2 for servicing purposes. A rearward frame portion 3 of the truck tractor is shown with a fifth wheel 4 thereon. A ramp extension 5 of the fifth wheel is typical of conventional fifth wheel structures which typically receives in normal use the forward end of the trailer and a king pin, all being standard items in the trucking industry.

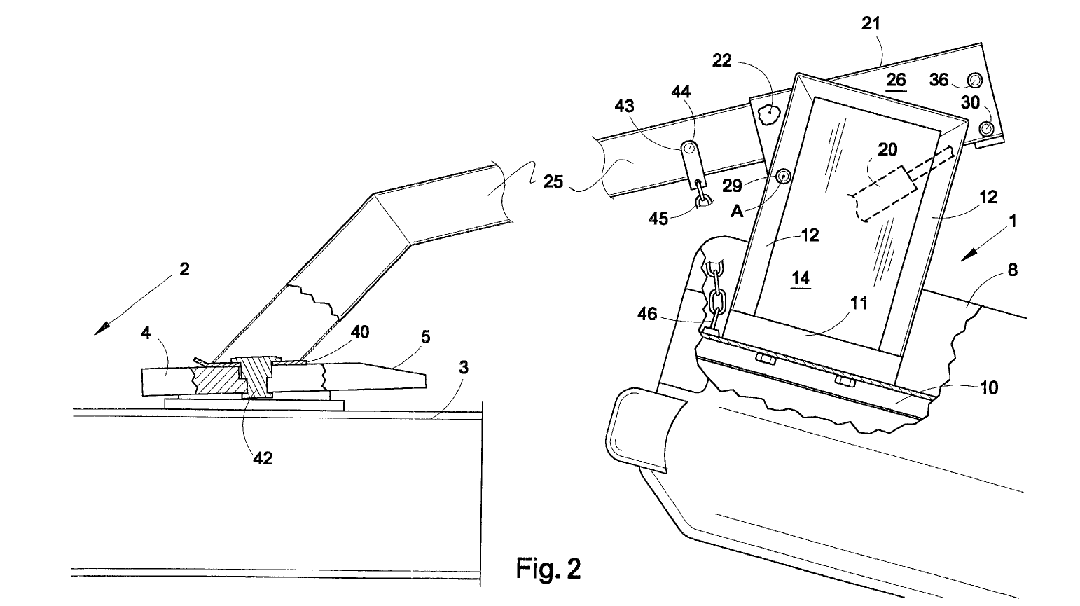

The present apparatus is indicated generally at 7 for installation in a truck box structure at 8. While a pickup truck vehicle is illustrated, upon an understanding of the invention, it will be apparent that other vehicles may prove suitable for use in conjunction with the present apparatus. A platform at 10 in FIG. 2 may be the truck bed preferably of corrugated steel plate. Bolted in place on platform 10 is a welded steel base including a framework 11 including spaced apart upright members 12 of welded construction and braces at 13. Cover plates 14 may be provided to conceal the following described hydraulic and electrical components.

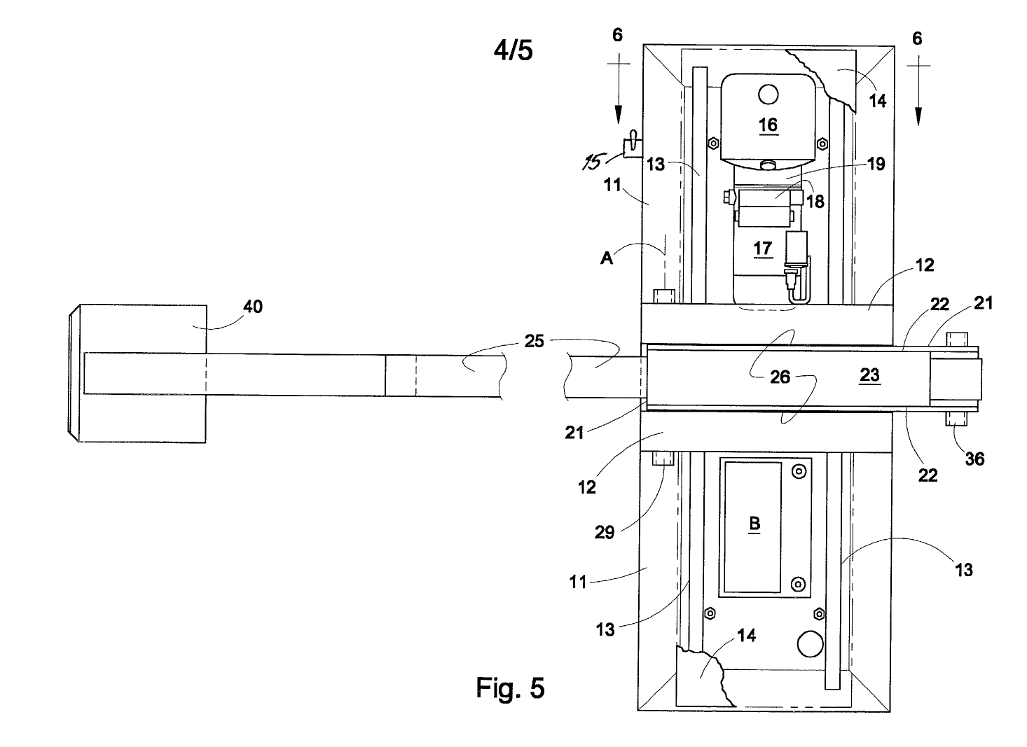

Carried by base 11 is a hydraulic oil tank 16 in FIG. 5 which serves a fluid circuit including a pump 19 powered by an electric motor 17 for powering a double acting hydraulic cylinder 20. The hydraulic circuit additionally includes a unitized pressure relief valve and a four way solenoid actuated control valve 18 serving hydraulic lines (not shown) in communication with the opposite ends of cylinder 20. Valve 18 is in circuit with a three position toggle switch 15 for operator control. A 12 volt battery is at B.

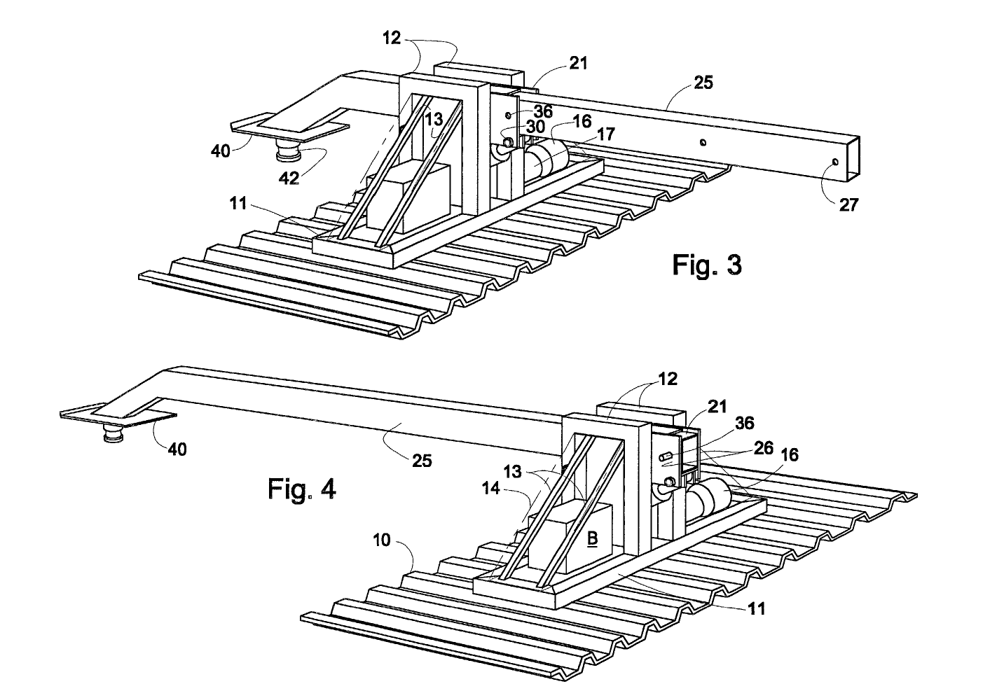

Carried by upright members 12 is a tow beam support 21 which is a weldment having side walls 22 in FIG. 5 and top and bottom walls 23 and 24 which form a four sided support for a tow beam 25 shown as a box beam. Beam support member 21 is carried by a frame mounted pivot pin 29 for upright travel of the support member about a horizontal axis at A along with tow beam 25 therein. A pair of side plates 26 are welded to side walls 22 of the support member for reinforcement of same and additional bearing surfaces. The side plates extend below support member 21. A clevis 24A on member 21 receives a pin 30 journaled in a bearing 31 on a piston rod 32 of hydraulic cylinder 20. The base end of the cylinder is swingably supported for travel about a pin 34 carried by upright structures 12. Tow beam 25 is preferably of box beam construction having an aperture at 35 for reception of a locking pin 36 to lock the beam in an extended operable position. A like aperture for pin reception may be provided in the tow beam for locking the beam in a retracted position as shown in FIG. 3.

The forward or distal end of tow beam 25 carries a skid plate 40 with the plate supporting a king pin 42. Tow beam 25 is positionable lengthwise from its stowed position shown in FIG. 3 to the extended position shown in FIG. 4, whereat skid plate 40 is positioned for contact with fifth wheel 4 of truck tractor 2. For hookup of the tow beam, the same is extended and locked into place in beam support 21, Upon entry of king pin 42 into the fifth wheel, the same is locked in place using conventional fifth wheel structure. Upon locking of tow beam 25 in place within the support structure, hydraulic cylinder 20 is pressurized for extension of piston rod 32 and downward loading of skid plate 40 to lift the back end of service vehicle 1.

Conventional fifth wheel construction permits limited rocking of the fifth wheel about a transversely extending horizontal axis which feature enables skid plate 40 to remain in surface engagement with the fifth wheel during lifting of the back end of the towed vehicle. At completion of a tow, the tow beam is returned to its initial position, approximately horizontal, by retraction of piston rod 32 to unload skid plate 40 and permitting unlocking of king pin 42. Prior to such unlocking, the towed vehicle 1 is in place with its rear wheels in ground contact. During towing the steering wheel of the towed vehicle is, of course, secured against movement. Tow beam 25 is locked during towing by a lock 43 (FIG. 2) having a pair of upright arms apertured to receive a pin 44 in a beam opening 39. The lower end of each arm has an opening to receive a chain 45 provided with a hook at one end for engagement with a shackle as at 46 in place on truck bed 10.

While we have shown but one embodiment of the invention, it will be apparent to those skilled in the art that the invention may be embodied still otherwise without departing from the spirit and scope of the claimed invention.

Having thus described the invention, what is desired to be secured by a Letters Patent is:

I claim:

1. An apparatus for lifting and towing a service vehicle with a truck tractor equipped with a fifth wheel, said apparatus including,
a base for installation on the service vehicle adjacent one end of the vehicle,
a tow beam having a proximal end and a distal end,
a beam support member extensibly supporting said tow beam permitting axial positioning of the tow beam,
pivot means coupling said beam support member to said base for travel of the tow beam and said beam support member about a horizontal axis.
locking means for securing said tow beam to said beam support member,
powered means coupled to said support member for positioning the support member about the horizontal axis,
a control for said powered means,
said tow beam including a king pin at its distal end for engagement with the tractor mounted fifth wheel,
actuation of said powered means imparting a lifting force to said proximal end of the tow beam and to said beam support member to elevate the base and that end of the service vehicle supporting said base for towing of the service vehicle.

2. The apparatus claimed in claim 1 wherein said base includes electrical and hydraulic components.

3. The apparatus claimed in claim 1 wherein said tow beam includes a plate at its distal end for surface engagement with a fifth wheel of a truck tractor.

4. The apparatus claimed in claim 1 wherein said powered means is a double acting hydraulic cylinder coupled to said base and to said beam support member.

5. The apparatus claimed in claim 1 wherein said locking means is a lock pin insertable in said beam support member and said tow beam.

6. The apparatus claimed in claim 4 wherein said control includes a four way solenoid actuated valve in communication with said hydraulic cylinder.
